(19) United States
(12) Patent Application Publication
(10) Pub. No.: US 2024/0383558 A1
(43) Pub. Date: Nov. 21, 2024

(54) ATTACHMENT OF AN ENERGY STORE TO A VEHICLE FRAME

(71) Applicant: ZF Friedrichshafen AG, Friedrichshafen (DE)

(72) Inventor: Finn Neumann, Blaustein (DE)

(21) Appl. No.: 18/579,063

(22) PCT Filed: Jul. 12, 2022
(86) PCT No.: PCT/EP2022/069483

§ 371 Date: Jan. 12, 2024

(30) Foreign Application Priority Data
Jul. 14, 2021 (DE) 10 2021 207 465.0

(51) Int. Cl. B62J 43/28; B62J 43/13; B62M 6/90

(52) U.S. Cl. CPC B62J 43/28; B62J 43/13; B62M 6/90

(57) ABSTRACT

The invention relates to an arrangement for fixing an energy storage device (101) on a vehicle frame, the arrangement having a guide groove (203) and one or more sliding blocks (201) which are designed to interlockingly engage into the guide groove (203). The arrangement has one or more holding means (205) which are at least partially arranged in the guide groove (203) and are each elastically deformable due to contact with a sliding block (201).

### CROSS-REFERENCE TO RELATED APPLICATION

The present application is related and has right of priority to German Patent Application No. 10 2021 207 465.0 filed on Jul. 14, 2021 and is a nationalization of PCT/EP2022/069483 filed in the European Patent Office on Jul. 12, 2022, both of which are incorporated by reference in their entirety for all purposes.

### FIELD OF THE INVENTION

The invention relates generally to an arrangement for fixing an energy storage device to a vehicle frame.

### BACKGROUND

Arrangements are known from the prior art for fixing a rechargeable battery on a bicycle frame, in which the rechargeable battery is interlockingly fixable on the bicycle frame. The energy storage device is insertable into correspondingly formed mounts by a guide groove. Such an arrangement is disclosed, for example, in document FR 3 091 690 A1.

The interlocking connection of the guide groove must cause essentially zero-backlash, so that the energy storage device does not rattle in the bicycle frame. This in turn causes the fixation of the rechargeable battery to become sluggish or jammed when there are unavoidable, tolerance-related dimensional deviations of the bicycle frame.

### SUMMARY OF THE INVENTION

The present invention provides an arrangement for fixing an energy storage device on a vehicle frame in a rattle-free manner.

The arrangement according to the invention is used for fixing an energy storage device on a vehicle frame. The vehicle frame is preferably a bicycle frame. The energy storage device is preferably a rechargeable battery, i.e., a rechargeable electric energy store, which supplies an electric auxiliary motor with drive energy.

The arrangement defines a guide groove. A groove is an elongate indentation in a surface. As compared to other indentations in a surface, a guide groove is distinguished by a cross-section which does not change along the course of the groove. The cross-section is therefore invariant as compared to a cutting plane oriented orthogonally to a curve describing the course of the groove.

A guide groove accommodates one or more fixing elements which are referred to as sliding blocks. The cross-sections of the guide groove and of the sliding blocks are matched to one another such that there is an interlocking connection between the guide groove and the sliding blocks.

The interlocking connection between the guide groove and the sliding blocks prevents relative motions between the guide groove and the sliding blocks which are orthogonal to the curve or axis describing the course of the groove. The guide groove and the sliding blocks are displaceable relative to each other in the direction of the curve.

Preferably, the cross-section of the sliding blocks forms a negative form of the groove. It is likewise preferred when at least a portion of each sliding block, which engages into the guide groove and enters into an interlocking connection with the guide groove, is a cylindrical body. The base area of the sliding blocks corresponds to the cross-section of the groove.

According to the invention, the arrangement also includes one or more holding elements or “holders.” The holding elements are arranged at least partially, preferably completely, in the guide groove. Displacing the sliding blocks in the guide groove, or vice versa, causes the holding elements to each come into contact with one sliding block.

The holding elements are at least partially elastically deformable. As a result, the holding elements elastically deform upon contact with a sliding block. Due to the elastic deformation, the holding elements exert a force upon the sliding block. As a result, the holding elements are braced between the sliding block and the guide groove. Any possible play that exists between the guide groove and the sliding blocks is eliminated in this way. A rattle-free fixation of the energy storage device is achieved as a result.

In one preferred development, the holding elements each consist of an elastomer. This is advantageous, since elastomers are comparatively low-cost and allow for a simple design of the holding elements.

In one instance, the guide groove is defined in or part of the vehicle frame, whereas the sliding blocks are mounted on the energy storage device or are defined as part of the energy storage device. Preferably, however, in some instances, the guide groove is defined in or part of the energy storage device, whereas the sliding blocks are fixed on the vehicle frame or are defined as part of the vehicle frame.

One preferred development includes a bar on which the sliding blocks are fixed. The bar is fixable or fixed on the vehicle frame. As a result, the sliding blocks are also fixable or fixed on the vehicle frame. Fixation by the bar according to the development is advantageous for stability reasons, in particular for vehicle frames having thin walls. It is also possible to preassemble the sliding blocks on the bar and to then install the bar, which includes the sliding blocks in the preassembled state, onto the vehicle. As a result, tolerance-related dimensional deviations of the vehicle frame do not affect the position of the sliding blocks relative to one another.

Preferably, the holding elements are developed such that they are deformable by the sliding block orthogonally to a course of the guide groove or orthogonally to the curve describing the course of the guide groove. A direction of the deformation of the holding elements and the curve are therefore oriented orthogonally to one another. As a result, a force resulting from the deformation of the holding elements also acts orthogonally to the curve. The force therefore does not result in a displacement of the sliding blocks in the guide groove. Instead, an interlocking connection is established between the holding elements and the sliding block, which counteracts a displacement of the holding elements in the guide groove.

Preferably, the arrangement is developed with at least one ejection and stop cam. The ejection and stop cam is at least partially arranged in the guide groove. An ejection and stop cam should be understood as a stop or stop element in relation to a first sliding block. The stop limits the displaceability of the first sliding block and thus also of the remaining sliding blocks in the guide groove in a first direction (or of the stop relative to the first sliding block). The stop also has a surface which is slanted, i.e., extending neither orthogonally nor antiparallel, with respect to the course of the guide groove or the curve which describes the course of the guide groove, the surface allowing a second sliding block, which differs from the first sliding block, to slide down upon displacement in the guide groove in the opposite direction, i.e., opposite the first direction, at least partially orthogonally to the direction of the displacement and thus at least partially orthogonally to the course of the groove or to the curve which describes the course of the groove. The surface is, in particular, a flat or linear surface.

Due to the ejection and stop cam according to the development, the energy storage device is fixable in an end position when the sliding blocks are displaced relative to the guide groove in the first direction. If the energy storage device is displaced from the end position in the opposite direction, the slanted surface of the ejection and stop cam comes into contact with the second sliding block, such that the energy storage device slides down orthogonally to such opposite direction of the displacement. This facilitates the removal of the energy storage device.

Preferably, the holding elements are arranged such that the elastic deformation according to the invention takes place in the end position. As a result, the energy storage device is fixable in the end position in a rattle-free manner. In addition, the energy storage device is preferably electrically contacted in the end position, such that a motor, in particular the aforementioned auxiliary motor, is supplied with electrical energy.

In one preferred development, the at least one ejection and stop cam is integrated with a holding element as one piece. This yields a particularly simple design.

### BRIEF DESCRIPTION OF THE DRAWINGS

Preferred exemplary embodiments of the invention are shown in the figures. Identical reference characters label identical or functionally identical features, wherein:

FIG. 1 shows a rechargeable battery for a bicycle, which includes a guide groove in accordance with aspects of the present subject matter;

FIG. 2 shows a partial cross sectional view of the rechargeable battery shown in FIG. 1, particularly illustrating a holding element defined on the rechargeable battery within the guide groove;

FIG. 3 shows a partial cross sectional view of the rechargeable battery shown in FIGS. 1 and 2, particularly illustrating an ejection and stop cam defined on the rechargeable battery within the guide groove; and

FIG. 4 shows a partial cross sectional view of the rechargeable battery shown in FIGS. 1-3, particularly illustrating a stop cam defined on the rechargeable battery within the guide groove.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

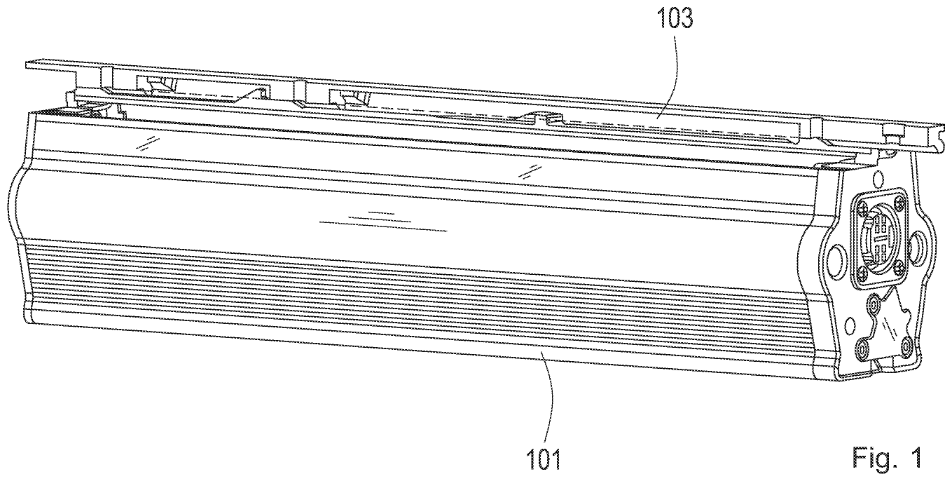

The rechargeable battery 101 shown in partial section view in FIG. 1 is fixable to a frame, such as a bicycle frame, by a fixing device 103 (shown in section view). The fixing takes place by inserting the rechargeable battery 101 into the fixing device 103 and displacing the rechargeable battery 1 to the right (from the perspective of FIG. 1).

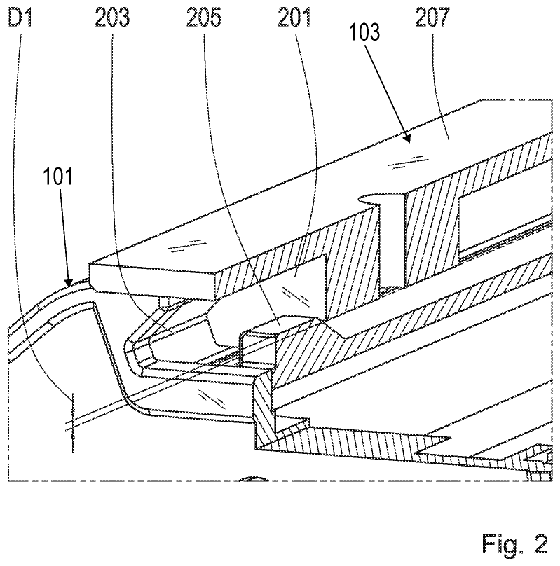

As shown in the section view of the rechargeable battery 101 and fixing device 103 in FIG. 2, the fixing device 103 includes sliding blocks 201. In order to fix the rechargeable battery 101 on the bicycle frame, the sliding blocks 201 engage into a guide groove 203 formed or defined by the rechargeable battery 101. The sliding blocks 201 are displaceable within the guide groove 203.

Holding elements 205 or “holders” are arranged on the rechargeable battery 101 at the base of the guide groove 203. The holding elements 205 are elastically deformable upon contact with a sliding block 201. A distance between the sliding blocks 201 and the base of the guide groove 203 is less, by an amount D1, than a height of the holding elements 205 with respect to the base of the guide groove 203. As a result, the above-described elastic deformation of the holding elements 205 takes place when the sliding blocks 201 are each pushed over a holding elements 205 or the holding elements 205 are each pushed under a sliding block 201.

The sliding blocks 201 are fixed on a bar 207.

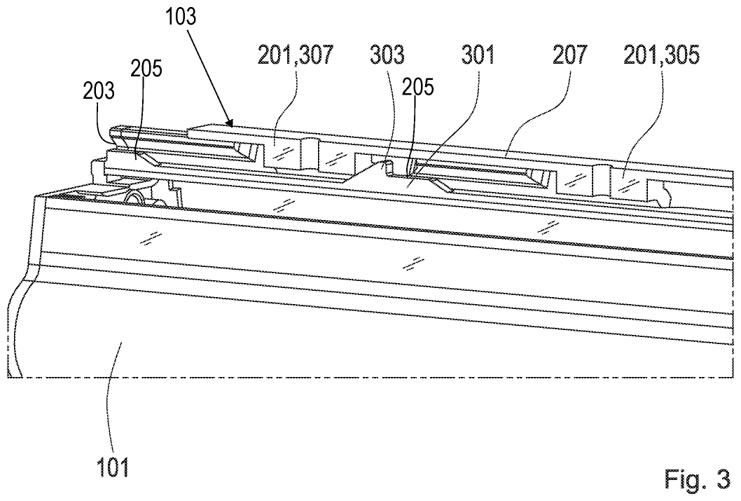

An ejection and stop cam 303 is integrally formed on a holding element 301 or “holder” (such as one or more of the holding elements 205) shown in FIG. 3. FIG. 3 also shows two sliding blocks 201. A sliding block 305 shown on the right (from the perspective of FIG. 3) enters into a frictional connection with the holding element 301 when the rechargeable battery 101 is displaced to the right (from the perspective of FIG. 3), such that the holding element 301 elastically deforms upon contact with the first sliding block 305, similar to the holding elements 205 in FIG. 2. A stop (vertically extending surface) formed by the ejection and stop cam 303 then impacts the first sliding block 305 and prevents the rechargeable battery 101 from being displaced further to the right.

Upon displacement to the left, a slanted surface of the ejection and stop cam 303 comes into contact with a second sliding block 307 which is shown on the left (from the perspective of FIG. 3). Due to engagement with the slanted surface, the ejection and stop cam 303 then slides down along the second sliding block 307, such that the rechargeable battery 101 is ejected out of the fixing device 103, in a direction at least partially orthogonal to the direction of the displacement to the left.

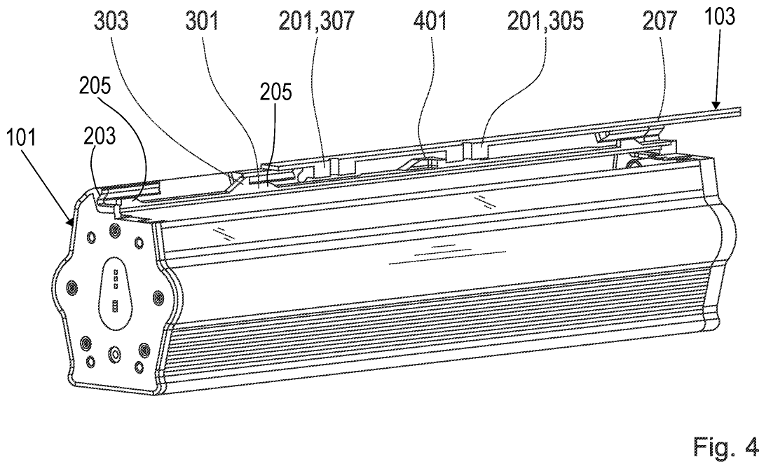

FIG. 4 shows a stop cam 401. The stop cam 401 forms a stop with respect to the first sliding block 305. The stop cam 401 comes into contact with the first sliding block 305 when the rechargeable battery is inserted into the fixing device 103 in the wrong position, as shown in FIG. 4. The stop cam 401 prevents the rechargeable battery 101 from being pushed from this position into the fixing device 103.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

101 rechargeable battery
103 fixing device
201 sliding block
203 guide groove
205 holder
207 bar
301 holder
303 ejection and stop cam
305 sliding block
307 sliding block
401 stop cam

1-6: (canceled)

7. An arrangement for fixing an energy storage device (101) on a vehicle frame, the arrangement comprising:
a part (101, 103) defining a guide groove (203), the guide groove (203) being configured to selectively, interlockingly engage with one or more sliding blocks (201); and
one or more holders (205) fixed on the part (101, 103) at least partially within the guide groove (203), each of the one or more holders (205) being elastically deformable and configured to elastically deform when contacting a sliding block (201).

8. The arrangement of claim 7, wherein the one or more holders (301) each consists of an elastomer.

9. The arrangement of claim 7, further comprising a bar (207) on which one or more sliding blocks (201) are fixed.

10. The arrangement of claim 7, wherein the one or more holders (301) are configured to elastically deform in a direction orthogonal to a course of the guide groove (203) when contacting a sliding block (201).

11. The arrangement of claim 7, further comprising at least one cam (303) fixed on the part (101, 103) within the guide groove (203), the cam (303) defining a stop portion and a slanted surface, the stop portion being configured to limit displaceability of a first sliding block (201, 305) within the guide groove (203) in a first direction, the slanted surface being configured to cause a second sliding block (201, 307) to slide at least partially orthogonally during displacement within the guide groove (203) in an opposite direction.

12. The arrangement of claim 11, wherein the cam (303) is integrated as one piece with a holder of the one or more holders.
